(19) United States
(12) Patent Application Publication
(10) Pub. No.: US 2015/0158155 A1
(43) Pub. Date: Jun. 11, 2015

(54) ROTARY IMPACT TOOL

(71) Applicant: Panasonic Intellectual Property Management Co., Ltd., Osaka (JP)

(72) Inventor: Hiroyuki TSUBAKIMOTO, Mie-ken (JP)

(21) Appl. No.: 14/562,147

(22) Filed: Dec. 5, 2014

(30) Foreign Application Priority Data
Dec. 11, 2013 (JP) 2013-256207

(51) Int. Cl. B25B 21/02; B25D 17/11

(52) U.S. Cl. CPC B25B 21/02; B25D 17/11

(57) ABSTRACT

A rotary impact tool includes an engagement element inserted into a hole formed by first and second grooves between a main hammer and a sub-hummer. The engagement element engages the main hammer with the sub-hammer in a rotating direction. The engagement element includes a core material and an elastic member covering an outer periphery of the core material.

### CROSS-REFERENCE TO RELATED APPLICATIONS

This application is based upon and claims the benefit of priority from prior Japanese Patent Application No. 2013-256207, filed on Dec. 11, 2013, the entire contents of which are incorporated herein by reference.

### BACKGROUND OF THE INVENTION

The present invention relates to a rotary impact tool.

A conventional rotary impact tool in which a main hammer and a sub-hammer strike an anvil in a rotating direction to fasten a bolt or a nut is known (for example, see Japanese Patent No. 4457170).

The rotary impact tool of Japanese Patent No. 4457170 suppresses so-called misalignment rotation in which an axial line of rotation of the sub-hammer from a central axial line of rotation of a spindle. In this manner, a rotational striking force obtained by a hammer is suppressed from being reduced while vibration in an axial line direction is moderated.

In the rotary impact tool as described above, grooves are formed in the main hammer and the sub-hammer, respectively. The groove of the main hammer forms a hole in collaboration with the groove of the sub-hammer. A needle roller is inserted into the hole. The needle roller is engaged with the grooves of both the hammers between the main hammer and the sub-hammer. In rotation of the hammers, the needle roller rotates integrally with both the hammers.

### SUMMARY OF THE INVENTION

When the hammers rotate, the needle roller is brought into contact with the grooves in the rotating direction of the hammers to generate unpleasant noise and vibration.

Accordingly, it is an object of the present invention to provide a rotary impact tool configured to suppress noise and vibration from being generated at an impact.

One aspect of the present invention is a rotary impact tool including a spindle that is rotated by a drive unit and has a spindle axis; an anvil arranged coaxially with the spindle; a main hammer that is directly or indirectly coupled to the spindle and is configured to be rotated around and axially moved in the spindle axis, the main hammer being configured to be engaged with the anvil to give impact to rotate the anvil; a sub-hammer that includes a cylindrical tube in which the main hammer is stored and into which the spindle is inserted, and rotates integrally with the main hammer; a first groove formed in an outer peripheral surface of the main hammer in parallel with the spindle axis; a second groove formed at positions corresponding to the first groove in an inner peripheral surface of the cylindrical tube of the sub-hammer, wherein the first and second grooves cooperate to form a hole between the main hammer and the sub-hummer; and an engagement element inserted into the hole formed by the first and second grooves to engage the main hammer with the sub-hammer in a rotating direction. The engagement element includes a core material and an elastic member covering an outer periphery of the core material.

Other aspects and advantages of the present invention will become apparent from the following description, taken in conjunction with the accompanying drawings, illustrating by way of example the principles of the invention.

### BRIEF DESCRIPTION OF THE DRAWINGS

FIG. 1 is a partially sectional view of a rotary impact tool according to an embodiment;

FIG. 2 is an exploded perspective view of an impact generation mechanism;

FIG. 3 is a perspective view for explaining an engagement element interposed on a boundary between the main hammer and the sub-hammer;

FIG. 4 is a sectional view for explaining the engagement element interposed on the boundary between the main hammer and the sub-hammer;

FIGS. 5A and 5B are plan views showing an outer peripheral surface of a spindle and an inner peripheral surface of the main hammer, the outer peripheral surface and the inner peripheral surface being developed in a circumferential direction; and

FIGS. 6A, 6B and 6C are pattern diagrams showing outer peripheral surfaces of the main hammer and an anvil, the outer peripheral surfaces being developed in the circumferential direction.

### DESCRIPTION OF THE EMBODIMENTS

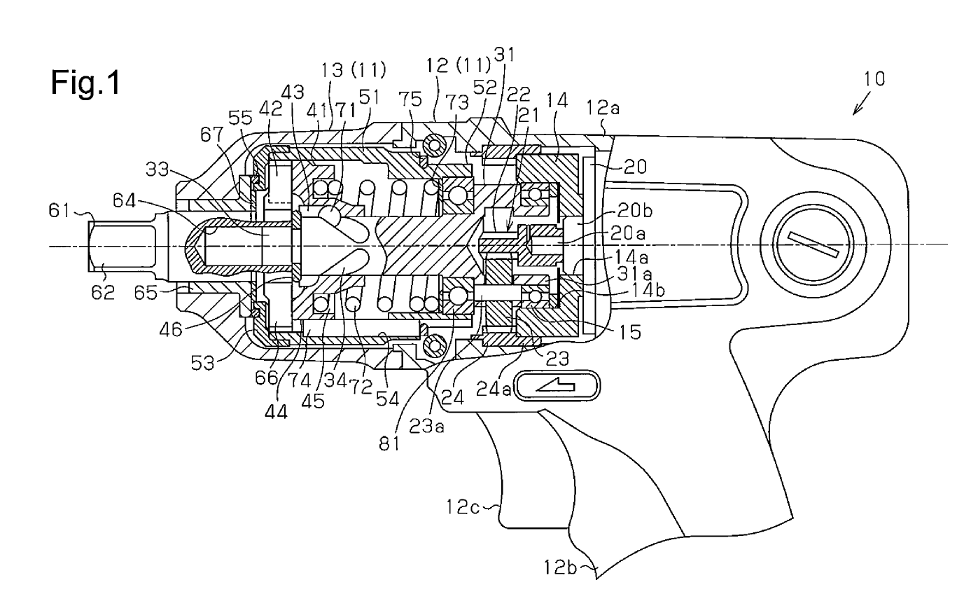

An embodiment of a rotary impact tool will be described below with reference to the accompanying drawings. As shown in FIG. 1, a rotary impact tool 10 is used as, for example, an impact wrench, and includes various members such as a drive unit 20 and a power transmitting mechanism 21 that are stored in a housing 11.

The housing 11 is configured of a rear housing 12 made of a synthetic resin and arranged at the rear end of the rotary impact tool 10 and a front housing 13 made of aluminum and arranged at the front end of the rotary impact tool 10.

The rear housing 12 has a cylindrical storing unit 12a in which the drive unit 20 configured of a motor and the power transmitting mechanism 21 for transmitting a rotational drive force of the drive unit 20 are stored and a grip portion 12b extending downward from the storing unit 12a to form a substantially T shape. On the grip portion 12b, an operation 12c switch 12c that can be press-controlled with a user is formed. At the lower end of the grip portion 12b, a battery (not shown) serving as a power supply of the drive unit 20 is arranged.

On the other hand, in the front housing 13, a spindle 31 that forms a cylindrical shape and configuring a rotational striking mechanism of the rotary impact tool 10, a main hammer 41, a sub-hammer 51, an anvil 61, and the like are stored. On the front housing 13, a tool attaching unit 62 of the anvil 61 projects from an opening at the front end of the front housing 13. The front housing 13 are fixed to the rear housing 12 with, for example, a plurality of screws (not shown).

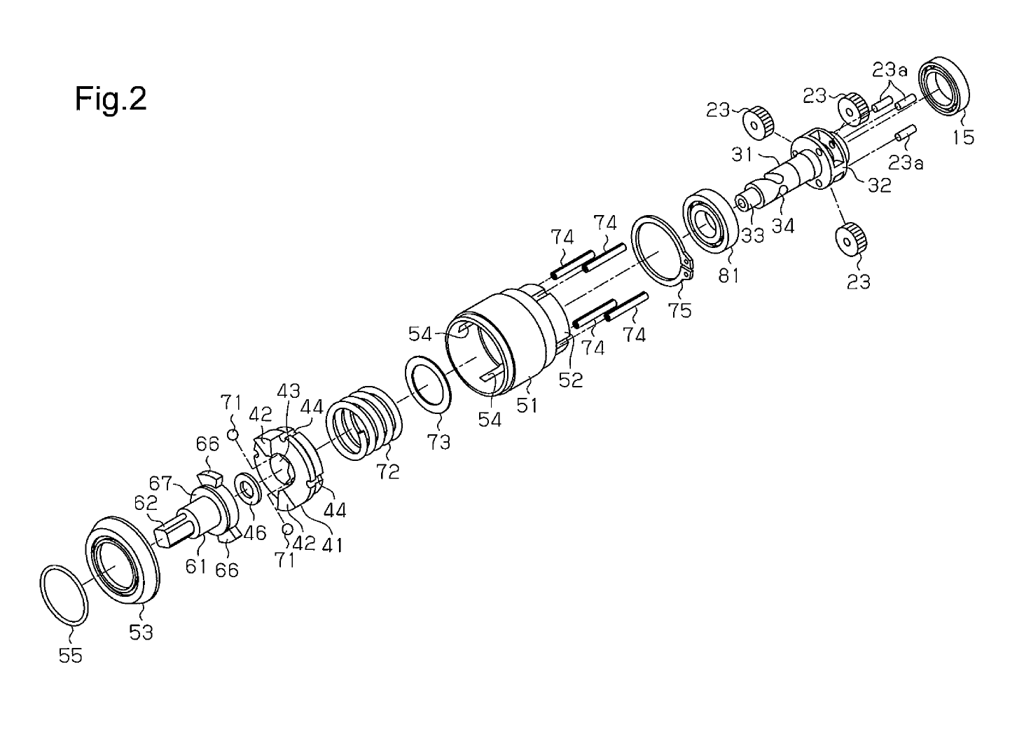

As shown in FIGS. 1 and 2, the power transmitting mechanism 21 stored in the rear housing 12 has a sun gear 22 press-fitted on a drive shaft 20a, three planet gears 23 meshed with the sun gear 22, and a ring gear 24 meshed with the planet gear 23.

As shown in FIG. 2, the planet gears 23 are rotatably supported by a support shaft 23a rotatably attached to an overhang portion 32 formed at the rear of the substantially columnar spindle 31.

As shown in FIGS. 1 and 2, the ring gear 24 is fixed on the inner peripheral surface of the cylindrical storing unit 12a. The ring gear 24 has a spacer 14 fixed to the inner peripheral surface of a rear part 24a a of the ring gear 24.

As shown in FIG. 1, the spacer 14 has a disk-like shape and through holes 14a and 14b of two types having different diameters at the center of the spacer 14. In the spacer 14, a front part 20a of the drive unit 20 is fitted in the through hole 14a on a relatively rear side to support the drive unit 20. In the spacer 14, a bearing 15 is fitted in the inner peripheral surface of the through hole 14b on a relatively front side, and the spindle 31 is rotatably supported in the bearing 15.

The power transmitting mechanism 21 configured as described above decelerates the rotation of the drive unit 20 in relation to a ratio of the number of teeth of the sun gear 22 to the number of teeth of the ring gear 24 and increases the torque so as to drive the spindle 31 at a low speed and a high torque.

As shown in FIG. 1, in the spindle 31, a rear end 31a at the rear of the overhang portion 32 is journaled by a bearing 15 arranged on the inner periphery of the through hole 14b on the front side of the spacer 14 fixed to the inner peripheral surface of the ring gear 24.

In front of the bearing 15 on the spindle 31, the overhang portion 32 formed by arranging two ring-like flanges at a predetermined interval is formed. As described above, between the two flanges of the overhang portion 32, the three planet gears 23 are rotatably supported on the support shaft 23a.

In front of the overhang portion 32 of the spindle 31, a substantially columnar projecting portion 33 is formed to extend. The projecting portion 33 is fitted in an engagement hole 64 formed at the rear of the anvil 61.

The substantially-disk-like steel main hammer 41 having a through hole formed in the central portion thereof is fitted on the outer periphery of the spindle 31.

The main hammer 41 has a pair of claw portions 42 projecting from the front end of the main hammer 41 toward the anvil 61. Between the main hammer 41 and the spindle 31, the main part of the rotational striking mechanism that can be rotated about an axial line of rotation of the spindle 31 and moved in an axial line direction, and rotationally strikes the anvil 61 is formed.

The rotational striking mechanism includes two first cam grooves 34 formed in the outer peripheral surface of the spindle 31, two second cam grooves 43 formed in the inner peripheral surface of the through hole of the main hammer 41, and two steel balls 71 arranged to be sandwiched between the first cam grooves 34 and the second cam grooves 43.

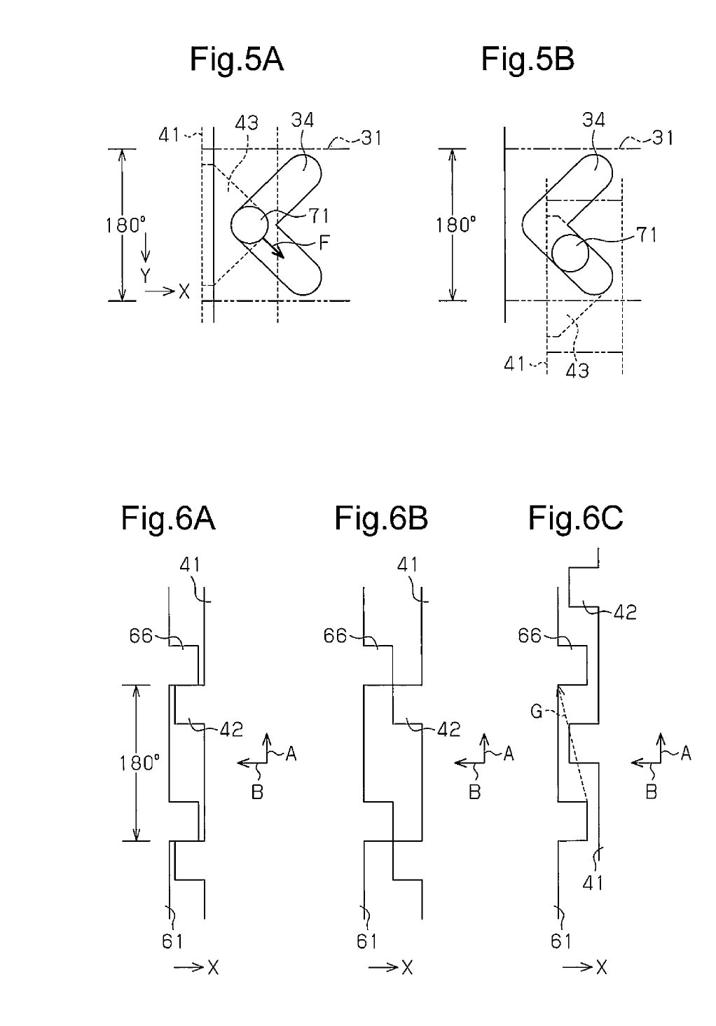

Furthermore, the rotational striking mechanism includes the sub-hammer 51, the anvil 61, and a spring 72 biasing the main hammer 41 toward the anvil 61. An operation of the rotational striking mechanism will be described below with reference to FIGS. 5A to 6C.

As shown in FIG. 1, on the outer peripheral side of the main hammer 41, the steel sub-hammer 51 having a cylindrical tube in which the main hammer 41 is stored, into which the spindle 31 is inserted to rotate, and which rotates integrally with the main hammer 41 is arranged.

The sub-hammer 51 has a small-diameter step 52 having a reduced outer diameter on the rear-end side of the sub-hammer 51, and a rear-end inner periphery of the small-diameter step 52 is press-fitted in an outer ring of a rolling bearing 81.

A ring-like cover 53 is fixed on the front-end side of the sub-hammer 51.

An integrally rotating mechanism in which the sub-hammer 51 and the main hammer 41 integrally rotate is disposed between both the hammers 41 and 51.

As shown in FIG. 2, the integrally rotating mechanism in which the main hammer 41 and the sub-hammer 51 integrally rotate includes at least one (for example, four) first groove 44 formed on the outer peripheral surface of the main hammer 41 and at least one (for example, four) second groove 54 formed on the inner peripheral surface of the cylindrical tube of the sub-hammer 51. Each of the first groove 44 and the second groove 54 has a semi-circular cross section and is formed in parallel with the axial line of rotation of the spindle 31. The first groove 44 and the second groove 54 are configured to form a circular hole in collaboration with each other.

From a rear end side of the sub-hammer 51, an engagement element 74 is fitted in the hole formed by the first groove 44 and the second groove 54. The engagement element 74 is a long member and has, for example, a substantially columnar shape.

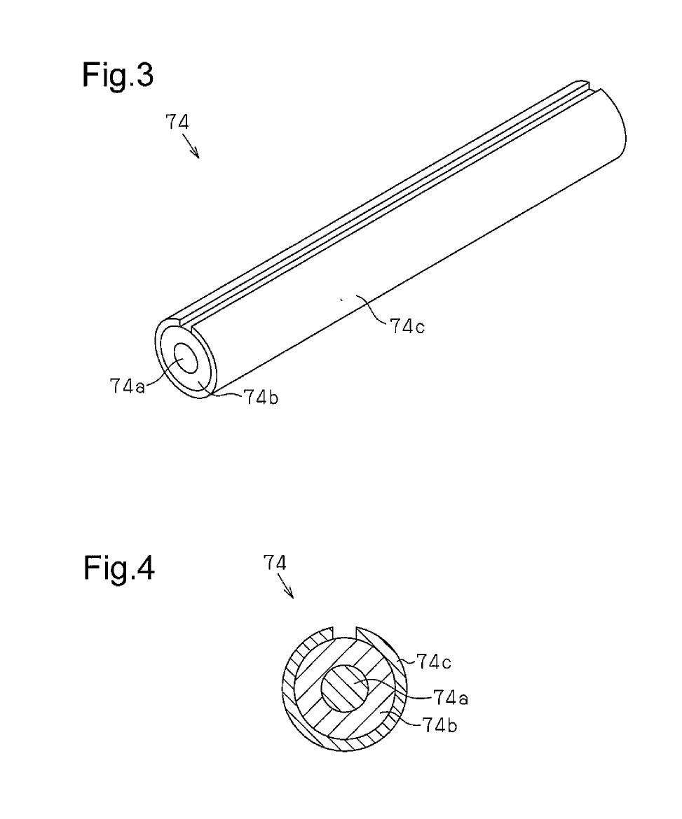

As shown in FIGS. 3 and 4, the engagement element 74 includes a columnar pin 74a serving as a core material, a cylindrical internal cover 74b covering the outer periphery of the pin 74a, and an external cover 74c covering the outer periphery of the internal cover 74b. The pin 74a is made of a metal material having relatively high rigidity. The internal cover 74b is an elastic member made of an elastic material such as elastomer. The external cover 74c is configured of a metal member. The external cover 74c is configured to have a substantially C-shaped cross section. For this reason, the external cover 74c has elasticity in a radial direction. The pin 74a is an example of a long rigid core, the internal cover 74b is an example of a first cushion sleeve, and the external cover 74c is an example of a second cushion sleeve.

On the small-diameter step 52 on the rear-end-side outer periphery of the sub-hammer 51, a C-shaped cover ring 75 having a locking function of the engagement element 74 is mounted. In this manner, the engagement element 74 is suppressed from improperly dropping out during the assembling operation of the rotary impact tool 10 to make the assembling operation easy.

In this manner, the engagement element 74 is fitted in the hole formed by the first groove 44 of the main hammer 41 and the second groove 54 of the sub-hammer 51 to make it possible to integrally rotate the main hammer 41 and the sub-hammer 51 about the axial line of rotation of the spindle 31.

The main hammer 41 can be moved in a longitudinal direction by using the engagement element 74 as a guide. However, in FIG. 1, the engagement element 74 and the grooves 44 and 54 are shown in the lower half, and are not shown in the upper half.

Between an annular recessed portion 45 formed on a rear side of the main hammer 41 and the outer ring of the rolling bearing 81 in which the rear-end inner periphery of the small-diameter step 52 of the sub-hammer 51 is press-fitted, the spring 72 is interposed through a washer 73 on the outer ring side, and the spring 72 biases the main hammer 41 toward the anvil 61.

The hammers 41 and 51 and the spring 72 integrally rotate about the axial line of the spindle 31. The spring 72 has helixes that are equal in outer diameter, so that the front end, the rear end, and the middle of the spring 72 all integrally rotate.

Thus, a torsion-preventing washer or a ball that is required when the rear end of the spring 72 is received by, for example, the spindle 31 is unnecessary, and the configuration of the rotational striking mechanism is simplified.

As shown in FIG. 1, the anvil 61 is made of steel, and is rotatably supported on the front housing 13 through a sliding bearing 65 made of steel or brass.

At the front end of the anvil 61, the tool attaching unit 62 having a square cross section is arranged to attach a socket body attached to the head of a hexagon bolt or a hexagon nut.

At the rear of the anvil 61, one pair of claw portions 66 engaged with the claw portions 42 of the main hammer 41 are arranged.

As shown in FIG. 2, each of the pair of claw portions 66 is formed in a fan-like shape and has an outer peripheral surface that is in contact with the inner peripheral surface of the front end of the cylindrical tube of the sub-hammer 51.

The pair of claw portions 66 of the anvil 61 has a function of holding a center of rotation when the sub-hammer 51 rotates.

The claw portions 66 of the anvil 61 and the claw portions 42 of the main hammer 41 need not be paired (two). When the numbers of claws are equal to each other, three or more claws may be arranged at equal intervals in each of the circumferential directions of the anvil 61 and the main hammer 41, respectively.

On the anvil 61, a ring-like flange 67 is formed to be in contact with the pair of claw portions 66.

On the outer peripheral side of the flange 67, the ring-like cover 53 is disposed to cover the front open end of the cylindrical tube of the sub-hammer 51, and an O ring 55 is disposed between the cover 53 and the sliding bearing 65 to prevent a gap from being formed between the cover 53 and the sub-hammer 51.

An operation of the rotary impact tool 10 according to the embodiment will be described below.

When the drive unit 20 rotationally drives, after the rotational drive force is decelerated by the power transmitting mechanism 21, the rotational drive force is transmitted to the spindle 31 to rotate the spindle 31 at a predetermined rotating speed. A rotating force of the spindle 31 is transmitted to the main hammer 41 through the steel balls 71 fitted between the first cam grooves 34 of the spindle 31 and the second cam grooves 43 of the main hammer 41.

FIG. 5A shows a positional relationship between the first cam grooves 34 and the second cam grooves 43 immediately after fastening a bolt or a nut is started. FIG. 6A shows an engagement state between the claw portions 42 of the main hammer 41 and the claw portions 66 of the anvil 61 at the same point of time.

As shown in FIGS. 6A to 6C, with rotation of the drive unit 20 (see FIG. 1), a rotating force A is applied to the main hammer 41 in a direction indicated by an arrow. The spring 72 applies a biasing force B in a straight forward direction to the main hammer 41 in a direction indicated by an arrow. There is some gap between the main hammer 41 and the anvil 61, and the gap is formed by a buffer member 46.

In rotation of the main hammer 41, the anvil 61 is rotated with engagement between the claw portions 42 of the main hammer 41 and the claw portions 66 of the anvil 61, and the rotating force of the main hammer 41 is transmitted to the anvil 61.

With the rotation of the anvil 61, the socket body (not shown) attached to the tool attaching unit 62 of the anvil 61 rotates to give a rotating force to the bolt or the nut, so that initial fastening is performed.

When a load torque applied to the anvil 61 increases with the progress of the fastening of the bolt or the nut, as shown in FIG. 5A, the main hammer 41 is rotated by the torque in a Y direction relative to the spindle 31.

While the steel balls 71 move along inclined surfaces of the first cam grooves 34 and the second cam grooves 43 in a direction indicated by an arrow F against the biasing force B of the spring 72, the main hammer 41 moves in an X direction.

As shown in FIG. 5B, when the steel balls 71 move along the inclined surfaces of the first cam grooves 34 and the second cam grooves 43, in response to this, the main hammer 41 moves in the X direction. At this time, as shown in FIG. 6B, the claw portions 42 of the main hammer 41 are disengaged from the claw portions 66 of the anvil 61.

When the claw portions 42 of the main hammer 41 are disengaged from the claw portions 66 of the anvil 61 to release the biasing force B of the compressed spring 72, the main hammer 41 advances at a high speed in a direction opposite to the X direction while rotating in a direction opposite to the Y direction.

As shown in FIG. 6C, the claw portions 42 of the main hammer 41 move along a track indicated by an arrow G to collide with the claw portions 66 of the anvil 61 so as to give a rotational striking force to the anvil 61.

Thereafter, with the counteraction, the claw portions 42 of the main hammer 41 move in a direction opposite to the direction of the track G. However, finally, the rotating force A and the biasing force B act to return the state of the claw portions 42 to the state shown in FIG. 6A.

The operations are repeated to repeatedly perform the rotational striking to the anvil 61.

The operation executed when the bolt or the nut is fastened has been described above. However, at the time of loosening a fastened bolt or nut, almost the same operations as those performed in fastening are performed by the rotational striking mechanism. In this case, the drive unit 20 is rotated in a direction opposite to the direction in fastening to cause the steel balls 71 to move in an upper right direction along the first cam grooves 34 shown in FIG. 6A, and the claw portions 42 of the main hammer 41 strike the claw portions 66 of the anvil 61 in the direction opposite to the direction in fastening.

An operation of the sub-hammer 51 in rotational striking will be described below in comparison with a rotary impact tool having only a main hammer.

When the claw portions 42 of the main hammer 41 are disengaged from the claw portions 66 of the anvil 61, the spring 72 is released from a compressed state, and energy accumulated in the spring 72 is discharged as kinetic energies of the main hammer 41 and the sub-hammer 51.

With the operations of the first cam grooves 34, the second cam grooves 43, and the steel balls 71, as indicated by the track G in FIG. 6C, the main hammer 41 advances while rotating at a high speed.

The claw portions 42 of the main hammer 41 collide with the claw portions 66 of the anvil 61 to give rotational impact to the anvil 61. The front end surface of the main hammer 41 collides with the rear end surface of the anvil 61 to give impact in an axial line direction.

Striking the anvil 61 by the main hammer 41 is performed, for example, about 40 times per second. With the impact given, vibrations occur in a direction orthogonal to the axial line of the spindle 31 and the axial line direction of the spindle 31.

Since these vibrations fatigue an operator to deteriorate operating efficiency and to numb his/her hand, the vibrations are preferably reduced as much as possible. Of the vibrations, a vibration in the axial line direction of the spindle 31 is generated mainly by impact given in the axial line direction by the main hammer 41. On the other hand, impact given in the axial line direction by the main hammer 41 does not contribute to fastening a bolt or a nut. An intensity of impact in the axial line direction by a hammer is in proportion to the mass of the hammer, and an intensity of rotational impact is in proportion to the moment of inertia (total sum of products of the masses of parts in an object and the squares of distances from the parts to a rotating axis).

When a rotational striking is performed to the anvil 61 by using one hammer, the mass of the hammer needs to be reduced to reduce impact in the axial line direction. However, since the moment of inertia decreases when the mass of the hammer is simply reduced, the rotational impact also decreases to weaken the rotational striking force of the anvil 61.

Thus, in the rotary impact tool 10 according to the embodiment, independently of the main hammer 41 fitted on the spindle 31, the sub-hummer 51 that rotates integrally with the main hammer 41 but does not move in the axial line direction of the spindle 31 is used to solve the above problems.

More specifically, the total sum of the masses of the main hammer 41 and the sub-hammer 51 is made almost equal to the mass obtained in the case where only one hammer is used, and the mass of the sub-hammer 51 is set to be larger than the mass of the main hammer 41.

In the hammer configuration described above, impact strength applied in the rotating direction of the anvil 61 and caused by releasing the spring 72 from the compressed state is in proportion to the moments of inertia of the hammers, i.e., a sum of the moments of inertia of the main hammer 41 and the sub-hammer 51.

On the other hand, the impact strength applied in the axial line direction by the main hammer 41 and the sub-hammer 51 is in proportion to the mass of only the main hammer 41.

Thus, mass of the sub-hammer 51 contributing only to the rotational impact strength is made larger than the mass of the main hammer 41 as much as possible to make it possible to reduce the impact strength applied in the axial line direction by the main hammer 41.

Furthermore, in the embodiment, by using the fact that the magnitude of a moment of inertia is in proportion to the square of a radius of rotation, the moment of inertia is increased.

More specifically, since most of the mass of the sub-hammer 51 having the cylindrical tube is concentrated on a large-radius part, a moment of inertia is larger than that obtained when a columnar sub-hammer having its mass concentrated on a center of rotation is employed, and an impact strength generated by the sub-hammer increases.

Thus, when the hammers (the main hammer 41 and the sub-hammer 51) according to the embodiment, the rotary impact tool 10 in which an impact strength applied in the rotating direction of the anvil 61 is large and a vibration generated in the axial line direction of the spindle 31 is small can be achieved.

Effects of the embodiment will be described below.

(1) The internal cover 74b of the engagement element 74 is made of rubber having elasticity higher than that of the pin 74a to suppress noise and vibration from occurring even when the grooves 44 and 54 are brought into contact with the engagement element 74 in the rotating direction.

(2) The external cover 74c is arranged to suppress friction of the engagement element 74 caused by sliding the main hammer 41. For this reason, the engagement element 74 can be improved in durability.

It should be apparent to those skilled in the art that the present invention may be embodied in many other specific forms without departing from the scope of the invention. Particularly, it should be understood that the present invention may be embodied in the following forms.

The external cover 74c of the engagement element 74 may be omitted.

The cross section of the external cover 74c is not limited to a C-shape, and, as long as the configuration has elasticity in the radial direction, the sectional shape of the external cover 74c may be arbitrarily changed. In the illustrated example, the external cover 74c lays out a linear slit parallel to the axial line of the engagement element 74. However, in another example, the external cover 74c may form a linear or curved slit inclining with respect to the axial line of the engagement element 74. As the slit, a V-shaped, W-shaped, or spiral slit may be used.

The above description is intended to be illustrative and not restrictive. For example, the above-described examples (or one or more aspects thereof) may be used in combination with each other. Other embodiments can be used, such as by one of ordinary skill in the art upon reviewing the above description. Also, in the above description of the embodiments, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

1. A rotary impact tool comprising:
a spindle that is rotated by a drive unit and has a spindle axis;
an anvil arranged coaxially with the spindle;
a main hammer that is directly or indirectly coupled to the spindle and is configured to be rotated around and axially moved in the spindle axis, the main hammer being configured to be engaged with the anvil to give impact to rotate the anvil;
a sub-hammer that includes a cylindrical tube in which the main hammer is stored and into which the spindle is inserted, and rotates integrally with the main hammer;
a first groove formed in an outer peripheral surface of the main hammer in parallel with the spindle axis;
a second groove formed at positions corresponding to the first groove in an inner peripheral surface of the cylindrical tube of the sub-hammer, wherein the first and second grooves cooperate to form a hole between the main hammer and the sub-hammer; and
an engagement element inserted into the hole formed by the first and second grooves to engage the main hammer with the sub-hammer in a rotating direction, wherein
the engagement element includes a core material and an elastic member covering an outer periphery of the core material.

2. The rotary impact tool according to claim 1, wherein
the engagement element includes a metal cover that covers an outer periphery of the elastic member and is elastically deformable in a radial direction.

3. The rotary impact tool according to claim 1, wherein the engagement element is at least one elongated member.

4. The rotary impact tool according to claim 1, wherein
the core material is a rigid pin, and
the elastic member is a first cushion sleeve covering the rigid pin.

5. The rotary impact tool according to claim 4, wherein
the first cushion sleeve is an elastomer sleeve.

6. The rotary impact tool according to claim 4, wherein
the engagement element includes a second cushion sleeve covering the first cushion sleeve.

7. The rotary impact tool according to claim 6, wherein
the second cushion sleeve is formed by a rolled sheet of metal.

8. The rotary impact tool according to claim 7, wherein
the rolled sheet of metal includes edges that are spaced apart from each other to form a slit therebetween.
